(19) United States
(12) Patent Application Publication
(10) Pub. No.: US 2004/0069149 A1
(43) Pub. Date: Apr. 15, 2004

(54) Steam cooker

(76) Inventor: Robert R. Wakefield, Falmouth, ME (US)

Correspondence Address: BOHAN, MATHERS & ASSOCIATES, LLC, PO BOX 17707, PORTLAND, ME, 04112-8707, US

(21) Appl. No.: 10/272,207

(22) Filed: Oct. 15, 2002

(51) Int. Cl. A23L 1/00

(52) U.S. Cl. 99/330

(57) ABSTRACT

A steamer for steam cooking food. The steamer has a base unit and a soft top and is particularly suited for steaming large quantities of food. The soft top is made of gas-impermeable fabric and seals around the base unit to provide a tightly sealed cooking enclosure for steaming food, such as lobster, corn, and steamer clams. The soft top has a zipper opening to provide access to the internal cooking enclosure. The soft top is provided in various sizes and shapes. The base unit includes a shallow reservoir for liquid and may include brackets for semi-permanently attaching a multiple-jet gas burner.

### BACKGROUND INFORMATION

1. Field of the Invention

The invention relates to the field of steam-cooking food. More particularly, the invention relates to a steam cooker.

2. Description of the Prior Art

Many types of portable cooking apparatus have been developed for preparing food. Such portable cooking apparatus include grills for cooking food directly over an open flame and cookers for heating, frying, steaming, or boiling food. Nevertheless, preparing large amounts of food that requires steaming, such as for a traditional lobster and clam dinner for a large group of people, the equipment and apparatus available has certain disadvantages that result in inconvenience, greater cost, and/or safety hazards. One of the largest conventional kettles available today is the turkey fryer, which comes with a support stand to support the cooker over a propane burner. The fryer can handle approximately 10-15 lobsters. So, for example, food preparation for a traditional lobster dinner for a group of 40 persons requires three kettles or turkey fryers, three gas burners, and three propane gas tanks, each with the necessary hose, connectors, and regulator, and this just for the lobster alone.

The disadvantages of such cumbersome cooking equipment are numerous. The preparation of food for a steamed lobster and clam dinner for 40 or more people requires so much heavy, and cumbersome equipment that a large vehicle, such as a pick-up truck or a van, is needed to transport it to the dinner site. The safety hazards multiply because of the need for multiple gas burners. In addition, because of the inherent safety risks involved with using gas and an open fire to prepare food, preparation of such a picnic or dinner generally requires more than one person to prepare, manage, and monitor the multiple cooker and fuel set-ups.

At a traditional lobster bake, all guests should be served all of the food, or at least the same food, at approximately the same time. With the conventional cookers, either a series of cookers are used or the guests are served in stages. Theoretically, it is possible to develop a kettle that would be large enough for steaming the lobsters, clams, and corn for a group of forty people. The cost of such a kettle would be prohibitive, the weight unmanageable, and the kettle far too bulky to be handled by a single person.

What is needed, therefore, is apparatus that is capable of steam-cooking large amounts of food at one time. What is further needed is such apparatus that is easy to carry and transport, and that requires only one heat and fuel source. What is yet further needed is such apparatus that is adaptable to accommodate various amounts of food.

### BRIEF SUMMARY OF THE INVENTION

For the reasons presented above, it is an object of the present invention to provide a steamer that is lightweight, easy to transport, and provides the necessary capacity to steam-cook a large quantity of food. It is a further object to provide such a steamer that includes a semi-permanently attached gas burner and that requires only one fuel source. It is a yet further object to provide such a steamer that is easily adaptable so as to accommodate and cook varying amounts of food in an efficient manner.

The objects are achieved by providing a steamer according to the present invention that includes a base unit and a soft top that attaches to the perimeter of the base unit and provides a tight enclosure for steam cooking food. The base unit has collapsible or otherwise adjustable legs, a shallow pan that serves as a liquid reservoir, a steam plate that fits across the shallow pan above the reservoir, and a lip around the perimeter of the base. The steam plate has an open, grid-like surface or perforations of some type that allow steam to rise from the reservoir and circulate within the steamer, and the shallow pan has curved, sloping sides, similar in shape to that of a wok, that encourage steam to roll up along the sides of the soft top to promote even distribution of heat and steam. The soft top is made of a flexible, food-grade fabric that is substantially gas impermeable. The bottom edge of the soft top fits tightly around the lip of the base unit so as to provide a sealed enclosure in which to steam-cook food.

The underside of the base unit is fitted with brackets that receive a conventional multiple-jet gas burner that is sized properly to produce the necessary heat to raise the water in the steamer to the desired temperature. The gas burner is semi-permanently attached to the brackets with threaded fasteners or some other suitable fastening means in such a manner that it does not have to be removed from the base unit when the steamer is collapsed for transport or storage between uses. This feature provides several advantages. Primarily, it reduces the chances of improperly securing the gas burner to the unit, since, ideally, it is attached to the base unit only once when the unit is assembled for the first time. It also reduces set-up time and storage needs if the burner remains securely attached to the base unit.

The base unit of the steamer according to the invention may be height-adjustable. The legs of the base unit are collapsible or foldable to allow the base unit to collapse to a relatively flat unit that can be placed in a storage case that is only a few inches high. This greatly simplifies storage and transportation of the unit. There are numerous ways of providing height-adjustable or collapsible support legs and it is intended that the scope of the invention include all suitable means for providing such support legs. One example of such support legs includes telescoping tubes, whereby an outer tube slidingly receives an inner tube of a slightly smaller diameter. The selected height is maintained by inserting a locking pin through aligned through-holes through the inner and outer tubes, or simply by an interference fit between the two tubes. Another example includes legs comprising a lower leg that is pivotably connected to an upper leg. The lower leg folds down or out into a support position and the pivot joint is locked into the support position by means of a pawl or snap-button, or other suitable means of locking the joint so that the lower leg is not inadvertently moved out of the support position.

The soft top of the steamer, when assembled over the base unit for use, may drape directly over the food without any additional support. As steam builds up within the cooking enclosure, the soft top is pushed up and out, providing a larger space in which steam can collect, as a means of maintaining relatively even cooking conditions throughout the cooking enclosure.

It is also within the scope of the present invention to provide a soft-top support frame that will support the soft top in a particular shape. Many types of support frame are suitable and possible, and it is intended that the scope of this invention include any type of support frame that fits the particular configuration of the soft top and is suitable for the purposes of cooking food within the steamer. For example, one configuration of the soft top has an essentially cylindrical shape with a sidewall and a top wall. A cylindrical support frame for this soft top configuration includes a lower ring that is supported on the perimeter of the base unit and vertical support members that extend from the lower ring to a removable upper ring. The vertical support members are dimensioned such that they hold the top wall of the soft top a specific distance above the perimeter of the base unit; the upper ring is dimensioned to fit within the contour of the soft top at the interface between the sidewall and the top wall.

The soft top according to the invention may be constructed such that it is pulled down over the support frame and cinched or otherwise tightly sealed around the perimeter of the base to provide a snug, sealed fit that impedes the escape of air or steam from the steamer at the interface between the soft top and the base unit. It is also within the scope of the invention to provide a soft top with a bottom edge that is vulcanized to the rim of the base unit. With this type of soft top, the support frame is assembled while the soft top is collapsed down around the base unit. Once the support frame is in place, the soft top is pulled up and fitted around the frame. With this particular configuration, loading/unloading product into the steamer is done from the top, without detaching the soft top from the base unit.

Another cylindrical support frame includes a center support pole having a pole base that is seated on the floor of the base unit. The upper end of the center support pole is topped with a center collar for receiving and holding ends of support members that are cantilevered out toward the perimeter of the top wall and secured by a retainer ring. The soft top may also have a configuration similar to that of a dome tent. A domed support frame includes semi-circular, flexible support members that fit into support-member receiver slots or holes spaced around the perimeter of the base unit.

Numerous configurations of the soft top are suitable for providing a structure for holding food within the base unit and include, in addition to the cylindrical and some shapes mentioned above, rectangular, and oval shapes. It is intended that all such suitable configurations be included within the scope of this invention.

The soft top is a key feature of the steamer according to the invention. One function of the soft top is to provide a structure for holding food stacked above a heat source. Another function is to provide a sealed enclosure in which the conditions of temperature and pressure allow food to be cooked. Suitable for this purpose are materials that are heat-resistant and relatively gas-impermeable and allow a build-up of steam slightly above atmospheric pressure and a temperature slightly above the boiling point of water. The soft top can be made of a single piece of fabric or multiple pieces that are sewn together or otherwise held together to form a sealed cooking enclosure when properly assembled over the base unit. In order to allow a person to open up the top of the soft top to check on the progress of the cooking or to load/unload the steamer, the soft top may have a sealable opening in it. For example, with the cylindrical soft top configuration, the side wall and top wall are connected by a zipper so that the top wall is partially separable from the side wall to provide access to the cooking enclosure or to release steam as a means of controlling the speed of the cooking, or it is completely removable to provide greater access to the cooking enclosure for ease of loading/unloading product. With the dome-tent configuration, multiple wall sections extend from the bottom edge of the soft top to the top center, having curved seams connecting adjacent wall sections. One or more zippers are used at the curved seams to provide a sealable connection between the respective two or more wall sections.

Other suitable means of creating a sealable opening in the soft top are also included within the scope of the present invention. One other means is that of using a hook-and-loop type fastener, such as VELCRO, to sealably connect the edges of two wall sections or the side wall and top together. The hook-and-loop material is attached to each edge of fabric that is to be connected in such a way that the edges of the soft-top fabric are first folded to impede the release of air or steam, with the folds then fastened in place with the hook-and-loop material.

As mentioned above, the soft top for the steamer according to the present invention allows a slight overpressure to build up inside the soft top when it is properly assembled around the base unit and heat is applied to the base unit. The soft top is constructed such, that when the pressure exceeds a certain point, air or steam escapes around the bottom edge of the soft top and/or through the zipper or hook-and-loop closure. A fold or flap of soft-op fabric or other gas-impermeable material is attached to the under side of the soft top to cover the zipper seam area to further impede the flow of steam through the closure and thereby to increase the pressure that builds in the cooking enclosure.

Food caterers or others who provide food to groups of people that vary widely in number may desire a steamer that is adaptable to the particular required capacity. For such cases, the steamer according to the present invention includes a multi-stage soft-top that extends upward to expand capacity. This multi-stage soft top has a base side wall with a lower edge that fits snugly around the perimeter of the base unit and multiple side wall sections that attach to the soft top between the base side wall and the top. As with the soft top described above, the multi-stage soft top may drape directly over the food assembled in the cooking enclosure, without an upper support frame, or may have a support frame comprising one or more support sections. For example, the upper support frame may include a base frame section and multiple extender frames that mount on top of the base frame section to create a steamer “tower.” Numerous methods of stacking and securing frame sections one atop the other are known and it is intended that the scope of this invention include any suitable means of stacking frame sections. Such methods includes seating an upper frame section on the upper edge of the base frame section and securing the sections to each other with fastener means, such as pawls that snap around the edges of the frame sections. Also included are methods of stacking sections that decrease in circumference from bottom to top, in order to minimize the tendency of the steamer tower to topple.

Since the steamer according to the invention may be used as a portable steamer, it is important that it be easily transportable and stowable in a single container. The steamer has multiple component pieces and is easily disassembled for storage. In one embodiment of the invention, the steamer is provided with a carrying case for receiving and carrying the component pieces. The steamer is partially disassembled for transportation in the carrying case by folding, collapsing, or removing sections of the legs of the base unit and collapsing or folding the soft top to form a substantially flat configuration that fits into the carrying case. In another embodiment, the steamer itself includes a transport structure that is attached to the base unit and is deployable as needed. For example, a transport structure similar to that of conventional rollable suitcases with an extendable handle is mountable on the base unit of the steamer. In this case, casters are attached to two or four of the legs and a telescoping frame that serves as a handle is attached to the base unit or the legs.

### BRIEF DESCRIPTION OF THE DRAWINGS

FIG. 1 shows the steamer according to the invention, assembled, with the soft top cinched around the base, the base supports fully extended, and the gas burner with burner shield in place.

FIG. 2 is a perspective view of the base of the steamer of FIG. 1, showing shallow pan, stanchion supports, collapsible base supports, and drain pipe.

FIG. 3 is a partial elevational view of the steamer of FIG. 1, illustrating the shape of the shallow pan and an embodiment of the upper frame that supports the soft top.

FIG. 4 is a cross-sectional elevational view of the Preferred Embodiment of the steamer according to the invention, showing a center-pole support frame for the soft top.

FIG. 5 is an elevational view of the base unit of the steamer, showing the location of the jet burner under the shallow pan.

FIG. 6 shows the steamer of FIG. 4, disassembled for storage or transportation.

FIG. 7 shows a travel carrier in which to transport the steamer of the present invention.

FIG. 8A shows the steamer according to the invention with an accordion-pleated, expandable soft top.

FIG. 8B shows the steamer according to the invention with an expanded, full-framed soft top.

FIG. 9 shows the steamer according to the invention with a dome-shaped soft-top.

FIG. 10 shows a detail of a flap of material covering the soft top enclosure.

FIG. 11A shows a rectangular-shaped steamer according to the present invention.

FIG. 11B shows an oval-shaped steamer according to the present invention.

FIG. 12 is an illustration of a steamer combined with a transport structure according to the invention.

### DETAILED DESCRIPTION OF THE INVENTION

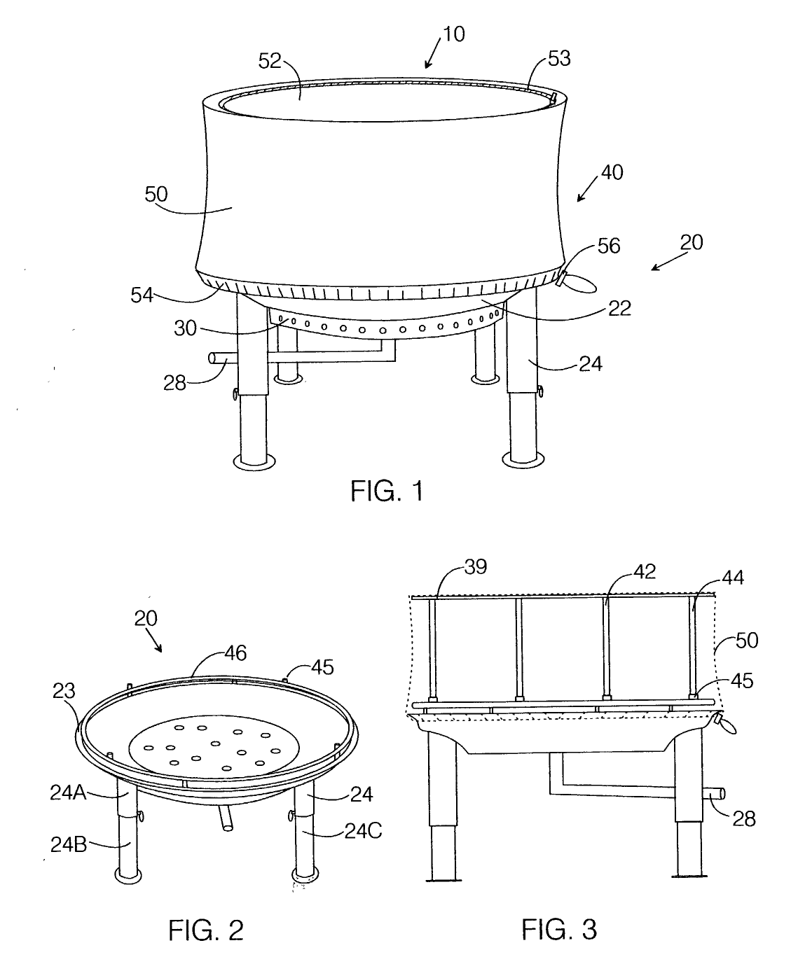

FIG. 1 shows a steamer 10 according to the invention. The steamer 10 comprises a base unit 20 and a soft top 40. The base unit 20 is shown in greater detail in FIGS. 2 and 3, and includes a shallow pan or reservoir 22 and base supports 24. A drain and drain pipe 28 with a drain cock are provided in the reservoir 22. A heat shield 30, shown in FIG. 1, is not shown in FIGS. 2 and 3 in order to more clearly illustrate the base unit 20.

The base supports 24 of the base unit 20 are shown as height-adjustable legs formed from metal tubing. In the embodiment shown, a lower tube 24B is slidingly received in an upper tube 24A and secured in position with a locking pin 24C. It is understood that numerous types of supports are suitable for the steamer 10 according to the invention, such as, for example, telescoping tubes with a height-adjustable locking mechanism, tubes with an interference fit, similar to the typical “vacuum-cleaner” or tent-pole extension tubes, pivotably secured supports that fold out of the way for storage, etc.

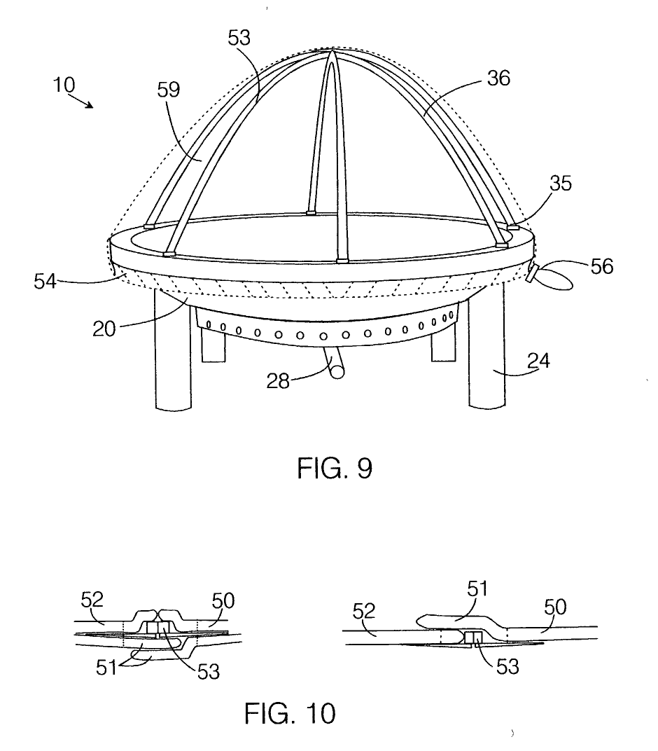

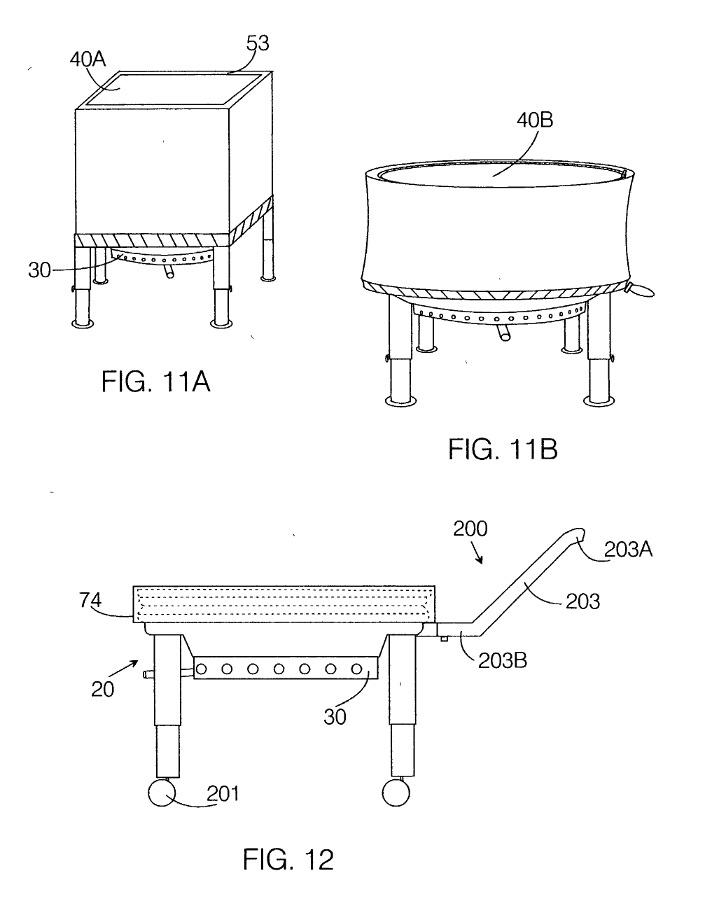

A first embodiment of the soft top 40 is shown in FIGS. 1 and 3. The soft top 40 is supported on an upper frame 42 that comprises a plurality of stanchions 44 that are seated in receptacles 45 on a support ring 46 that is mounted on the rim of the shallow pan 22. In order to maintain the proper orientation of the stanchions 44, an upper ring 39 may be fitted atop the upper ends of the stanchions 44, or loops or other types of retainers constructed to receive the upper ends of the stanchions 44 may be provided in the soft top 40. The soft top 40 comprises a side wall 50 and an openable top 52. In the embodiment shown, the side wall 50 is cylindrical in shape. Other suitable shapes are included within the scope of the invention and are shown in FIGS. 9, 11A, and 11B. In the embodiment shown in FIGS. 1 and 3, the openable top 52 is flat and is removably attached to the side wall 50 by means of an openable closure 53, which, in the embodiment shown in FIG. 1, is a zipper. A bottom edge 54 of the side wall fits around the outer perimeter of the shallow pan 22 and is sealable around a lip 23 formed on the shallow pan 22 by means of an adjustable sealing means 56. In the embodiment shown, the adjustable sealing means is a drawstring and a spring-loaded drawstring fastener. Other suitable means of sealing the bottom edge 54 of the soft top 40 around the shallow pan 22 are included within the scope of the invention. Such means include, but are not limited to, an elasticized bottom edge, a snap fastener, a draw-bolt, a hook-and-loop type closure, a vulcanized seal between the bottom edge 54 and the perimeter of the shallow pan 22, or any combination thereof that allows the soft top 40 to provide a sufficient seal with the shallow pan 22 that will allow a slight overpressure to build up within the enclosure.

Preferably, the material used for the soft top 40 is a food-grade, flexible, heat-resistant and gas-impermeable material. Examples of suitable materials include composite materials comprising a substrate of woven fiberglass mat or fabrics made of aramid fibers, such as KEVLAR®, covered with a food-grade flexible material such as a rubber silicone material, silicone rubber, canvas, aluminum foil, and other suitable materials. When cooking some types of food, for example, when steaming lobsters and clams, it is desirable to have steam accumulate within the cooking enclosure sufficiently to create a slight overpressure. This ensures an even distribution of heat and steam, resulting in uniform cooking conditions throughout the enclosure, despite the large amount of food that is being prepared within the enclosure at one time. For this reason, a gas-impermeable material is preferable. The steam will eventually escape the cooking enclosure, not through the material but at the upper and lower extremes of the cooking enclosure, for example, at the interface between the bottom edge 54 of the soft top 40 where it is cinched around the base unit 20, and also through the seams connecting the side wall 50 and the openable top 52, and, if a zipper is used as the means of enclosure 53, through the interfaces at the zipper teeth. In order to impede the escape of steam, a flap 51 is provided in the soft top 40 that covers the enclosure 53, as shown in FIG. 10.

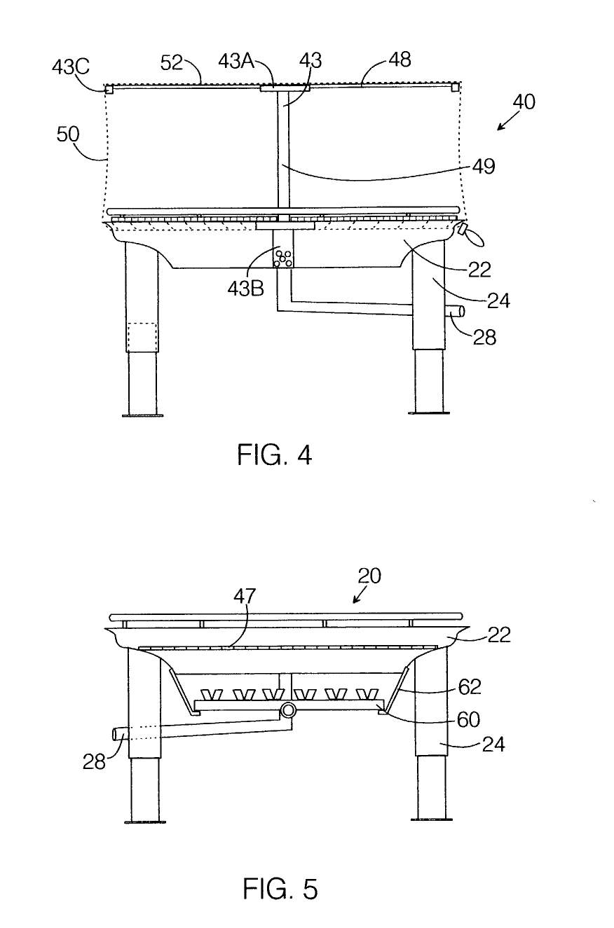

A second embodiment of the soft top 40 is shown in FIG. 4. The soft top 40 is essentially cylindrical in shape, with the side wall 50 and the openable top 52 as described above. A center-pole support frame 49 of this embodiment, however, resembles more an “umbrella” support frame that includes a single center-pole 43, having a lower pole base 43B and an upper pole end with a spoke receptacle collar 43A, a plurality of spokes 48, and a retainer ring 43C. The lower pole base 43B sits on the bottom of the shallow pan 22. As shown, the base 43B sits over the drain in the pan and is perforated to allow water to drain from the shallow pan 22, without first removing the center pole 43. The plurality of spokes 48 are attached to the collar 43A at the top of the center-pole 43 and extend outward toward an outer perimeter of the openable top 52. For reasons of stability, the outer ends of the plurality of spokes 48 are retained in the retainer ring 43C. As with the embodiment described above, the soft top 40 is draped over the center-pole support frame 49 and cinched tight around the perimeter of the shallow pan 22, thereby providing a support that maintains the essentially cylindrical shape of the soft top 40.

The shallow pan 22 is shown in profile in FIGS. 4-5. With the traditional lobster dinner, the food (lobster, steamers, corn-on-the-cob) is steamed, not boiled. A steam plate 47 or perforated flat plate is fitted across the open top plane of the shallow pan 22 to allow steam to rise from the shallow pan 22 into the cooking enclosure formed by the soft top 40, and to prevent food from coming into contact with water. In the embodiments shown, the shallow pan 22 has the shape similar to that of a wok, rather than a cylindrical shape. This shape encourages the steam to roll up along the sides of the cooking enclosure formed when the soft top is closed, thereby promoting even distribution of steam throughout the enclosure. A suitable material for the steam plate 47 is 14 gauge stainless steel and for the shallow pan 22 is 11 or 12 gauge stainless steel, finished on both sides.

FIG. 5 shows the base unit 20 of the steamer 10, with a conventional, multi-jet gas burner 60 fitted into burner brackets 62 that are mounted on the bottom of the shallow pan 22. The burner used in the first embodiment is a 23-jet conventional burner that produces 100,000 Btu. Ideally, the gas burner 60 is semi-permanently attached to the base unit 20 when the steamer 10 is initially set up. Threaded fasteners or other types of suitable fasteners that allow the burner 60 to be removed as required are preferably used to attach the gas burner 60 to the base unit 20, which then remains affixed to the base unit 20, even when the steamer 10 is partially disassembled for transportation and storage. This provides the advantage that the burner 60 can be properly and securely installed during the initial set-up and then remain so installed for repeated, subsequent uses. In addition to reducing set-up time, having such a partially pre-assembled base unit and burner also ensures optimal conditions for cooking, with respect to the distance of gas jets from the steamer and proper position of burner unit under the center of the base unit.

The steamer 10 according to the invention is also usable without the semi-permanently attached gas burner 60. For example, the steamer can be placed over an open fire pit or coals, or any other suitable heat source, depending on the intended use.

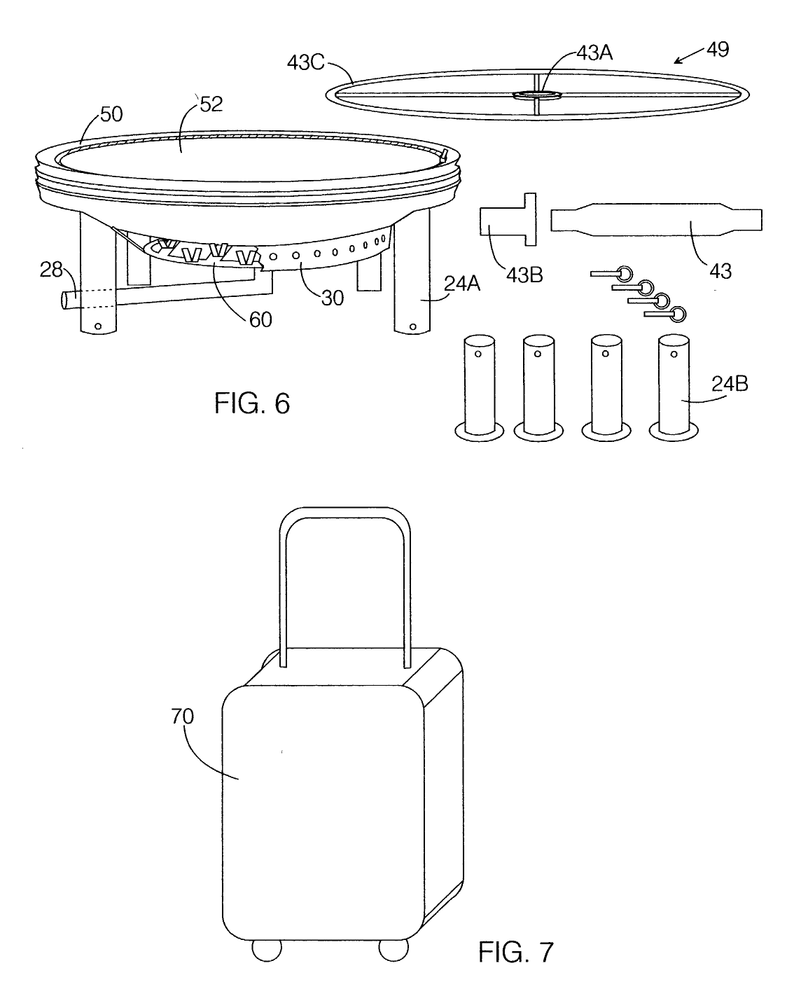

FIG. 6 is an illustration of the steamer 10 disassembled for transportation. The lower tubes 24B of the height-adjustable legs or base supports 24 have been removed, the soft top 40 unzipped, the upper support frame 42 removed and taken apart, and the soft top 40 collapsed down into the shallow pan 22. The gas burner 60 is still attached. The entire disassembled steamer 10 is only a few inches high and is easily stored in a carrying case 70, such as the one shown in FIG. 7

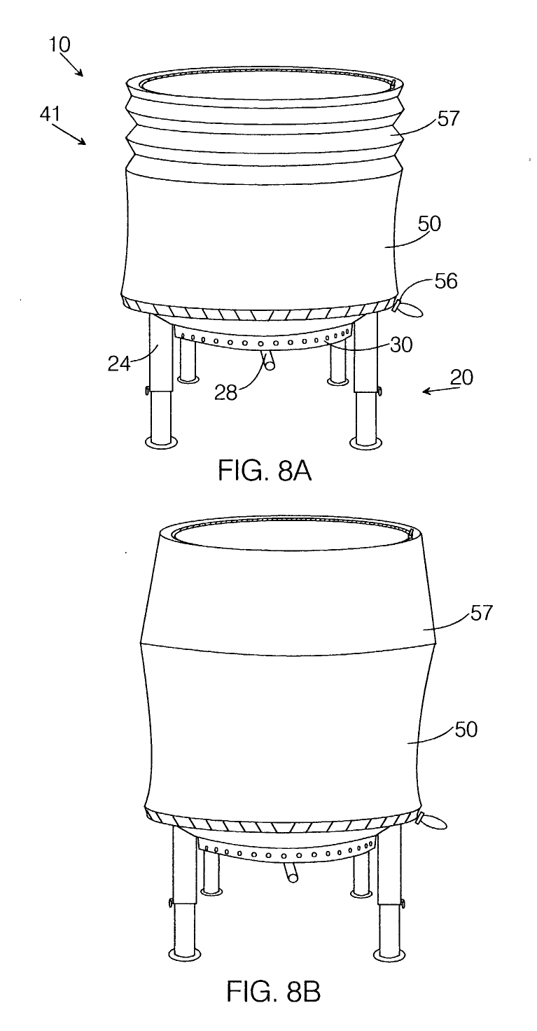

FIGS. 8A, 8B, and 9 illustrate various configurations of the soft top. An expandable soft top 41 is shown in FIG. 8. As shown, an expansion section 57 is added to the soft top 40 between an upper edge of the side wall 50 and the outer edge of the top wall 52. In the configuration shown, the upper support frame 42 does not extend up into the area of the expansion section 57, but rather, the expansion section 57 is allowed to rest in a folded or collapsed state on top of the food within the cooking enclosure. As steam builds within the enclosure, the expansion section 57 may rise to accommodate the increased volume of steam until a certain pressure is reached. It is, of course, possible to seat an expansion frame section on top of the upper support frame 42 so that the expansion section 57 is held as a substantially rigid expansion section, as shown in FIG. 8B. FIG. 9 illustrates a dome-shaped soft top 59 which is constructed of a plurality of panels sewn together and fitted over a frame formed by a plurality of flexible support struts 36 fitted into strut retainers 35 that are provided around the outer perimeter of the base unit 20. The openable closure 53 is a zipper. The dome-shaped soft top 59 can also be used without the frame, whereby the bottom edge 54 is fitted over the base unit and the upper portion of the top allowed to drape across the top of the base unit 20 (and across any food that is placed within the enclosure formed by the soft top 59. FIGS. 11A and 11B illustrate a rectangular soft top 40A and an oval soft top 40B, respectively.

FIG. 12 illustrates a portable steamer with a transport structure 200 according to the invention. Two or four of the base supports 24 are fitted with lockable casters 201. A handlebar 203 is removably attached to a portion of the base unit 20 with a conventional tube locking mechanism and allows one to pull the steamer along on the two or four casters 201. The soft top 40 of the combination steamer with transport structure 200 as shown in FIG. 12 has been collapsed into a storage and transportation configuration and the handlebar 203 is attached for use. Ideally, a separate protective covering 74 is fitted over the soft top 40 and attached to the base unit 20 to protect the soft top 40 when the steamer 10 is not in use. It is, of course, possible, to cover the soft top 40 with a flexible cover that is simply secured with elastic shock cords or straps to the base unit 20. Indeed, the types of protective coverings that are suitable for covering the soft top are numerous and it is intended that the scope of the invention encompass a portable steamer with transport structure that allows one to roll the steamer onto the site, and to cover the steamer in its collapsed state for transportation and storage.

Although the steamer 10 according to the present invention has been described above with reference to preparing large quantities of food, it is well within the scope of the present invention to size the steamer 10 appropriately for preparing individual or family-sized portions of food. For such an application, the steamer 10 is placed directly over the burner on a conventional stove or heat source. Accordingly, the base unit 20 does not require the base supports 24. Since the steamer 10 is sized for smaller quantities of food, it is easily manageable by a person and no longer requires a drain for draining liquid from the shallow pan as a person can pick up the shallow pan and pour the liquid into a sink, for example. In a further embodiment, an individual- or family-sized steamer 10 is constructed specifically for use with a microwave, and, as such, the base unit 20, as well as the soft-top 40 is made of heat-resistant, microwavable material.

The detailed description of the invention includes descriptions of specific embodiments. It is understood, however, that a person skilled in the art is capable of implementing many variations and modifications of the invention without straying from the intended scope of the present invention.

What is claimed is:

1. A steamer comprising:
a soft-top having a lower edge, said soft top being made of a flexible material;
a base unit having an outer perimeter and a water reservoir;
wherein said lower edge of said soft top closes around said outer perimeter so as to provide an enclosed cooking area.

2. The steamer of claim 1, wherein said base unit includes a steam plate that extends across said water reservoir.

3. The steamer of claim 1, wherein said flexible material is gas-impermeable.

4. The steamer of claim 1, wherein said soft-top has a side wall and a top wall.

5. The steamer of claim 4, further comprising an upper support structure that is mountable on said base, wherein said upper support structure supports said top wall a certain distance above said base.

6. The steamer of claim 5, wherein said outer perimeter of said base unit includes a plurality of support member receptacles and said upper support structure includes a plurality of vertical support members, a lower end of one of said vertical support members being seatable in a corresponding one of said vertical support member receptacles, and wherein said vertical support members provide support for said side wall and said top wall.

7. The steamer of claim 6, wherein each of said vertical support members has an upper end, and wherein said upper support structure includes a support stabilizing element that seats cooperatively with said upper end of said vertical support members to provide a stable support frame for said soft top.

8. The steamer of claim 5, wherein said upper support structure includes a center pole and a spoke ring assembly comprising a spoke receptacle collar, a plurality of spokes and an outer spoke ring having a circumference that corresponds to an outer circumference of said soft top;
wherein said center-pole has a lower center pole end with a center-pole base that is supportable in said shallow pan and an upper center-pole end; and
wherein said spoke receptacle collar mounts on said upper center-pole end and supports said plurality of spokes and said outer spoke ring.

9. The steamer of claim 8, wherein said upper support structure further includes a center support collar that is fitted around said center pole toward said lower end of said center pole, wherein said steam plate includes a centrally-located through-hole through which said center pole is receivable, and wherein said steam plate is supportable on said center support collar.

10. The steamer of claim 4, wherein said soft top is an expandable soft top that is adaptable to cover varying amounts of food.

11. The steamer of claim 10, wherein said side wall has an upper side wall edge, wherein said extendable soft-top includes an intermediate side wall panel with a lower edge and an upper edge, and wherein said lower edge is attachable to said upper side wall edge and said upper edge is attachable to said top wall, so as to form an upwardly extended side wall.

12. The steamer of claim 11, wherein said upper support structure includes an intermediate support section that corresponds in height to said intermediate side wall panel, and wherein said intermediate support structure seats atop said vertical support members of said upper support structure so as to provide support for said intermediate side wall panel and said top wall.

13. The steamer of claim 10, wherein said center pole includes an extender pole that is seatable on said center pole, and wherein said upper center pole end and said spoke receptacle collar are assembled at an upper end of said extender pole.

14. The steamer of claim 1, wherein said flexible material is food-grade material.

15. The steamer of claim 1, wherein said flexible material comprises silicone-coated fiberglass.

16. The steamer of claim 1, wherein said flexible material comprises silicone-coated fabric of aramid-based material.

17. The steamer of claim 1, wherein said base unit further comprises support legs.

18. The steamer of claim 17, wherein said support legs are collapsible.

19. The steamer of claim 17, wherein said support legs have an upper leg section and a lower leg section that are removably connectable by means of a slip joint.

20. The steamer of claim 17, wherein said legs have an upper leg section and a lower leg section that are slidingly adjustable by means of a telescoping mechanism.

21. The steamer of claim 17, wherein said legs have an upper leg section and a lower leg section that are foldable relative to each other.

22. The steamer of claim 1 further comprising a heat source.

23. The steamer of claim 22, wherein said heat source is a gas burner.

24. The steamer of claim 23, wherein said base unit includes a bracket in which said gas burner unit is semi-permanently mountable.

25. The steamer of claim 23, wherein said gas burner is permanently mounted on said base.

26. The steamer of claim 22, wherein said heat source is an electric burner.

27. The steamer of claim 22, wherein said heat source is a combustible material.

28. The steamer of claim 1 further comprising a transportation structure, said transportation structure including a rolling means and a handle for providing control of said rolling means.

29. The steamer of claim 28, wherein said transportation structure is attached to said base unit.

30. A steamer kit including said steamer of claim 1 and a storage case, wherein said steamer, when disassembled to a storage configuration, is stowable in said storage case.
